(19) United States
(12) Patent Application Publication
(10) Pub. No.: US 2021/0150656 A1
(43) Pub. Date: May 20, 2021

(54) SERVICE MANAGEMENT DEVICE, SERVICE PROVIDING SYSTEM, AND SERVICE MANAGEMENT METHOD

(71) Applicant: HONDA MOTOR CO., LTD., Minato-ku, Tokyo (JP)

(72) Inventors: Yuji Yasui, Wako-shi (JP); Hisao Asaumi, Wako-shi (JP); Shion Tokunaga, Wako-shi (JP); Masashi Yuki, Wako-shi (JP); Yo Ito, Tokyo (JP); Hirotaka Uchitomi, Tokyo (JP)

(21) Appl. No.: 16/622,007

(22) PCT Filed: Jun. 15, 2018
(86) PCT No.: PCT/JP2018/022825

§ 371 Date: Dec. 12, 2019

(30) Foreign Application Priority Data
Jun. 16, 2017 (JP) 2017-118691

(51) Int. Cl. G06Q 50/30; G06Q 10/06; G06Q 10/02; G05D 1/02; G01C 21/34

(52) U.S. Cl. CPC G06Q 50/30; G06Q 10/06315; G06Q 10/02; G05D 1/0088; G01C 21/3438; G05D 2201/0213; G05D 1/0297

(57) ABSTRACT

Provided is a service management device (300, 700) including an acquisitor (320, 720, 722, 724) that acquires a riding-together request (service use request information) for a service user U to request riding together with a service provider S within a moving vehicle (200, 500), and a plan decider (330, 740) that decides a riding-together plan of the service user and the service provider in response to the riding-together request acquired by the acquisitor.

### TECHNICAL FIELD

An aspect of the present invention relates to a service management device, a service providing system, and a service management method.

Priority is claimed on Japanese Patent Application No. 2017-118691, filed Jun. 16, 2017, the content of which is incorporated herein by reference.

### BACKGROUND ART

In the past, an invention of a system that accepts input of information indicating a position of a service providing place, information indicating a transportation position of a user to whom a service is provided, and information indicating the number of occupants in a vehicle used in transportation to store the accepted input in a storage, calculates transportation routes of a plurality of patterns for transporting the user by the vehicle between the position of the service providing place and the transportation position of the user, calculates a departure time and an arrival time for the service providing place of the vehicle in the transportation route of each pattern using predetermined map information, and decides a pattern of the transportation route on the basis of a departure time of the vehicle departing from the service providing place and an arrival time of the vehicle arriving at the service providing place in each pattern was disclosed (see Patent Literature 1).

### CITATION LIST

### Patent Literature

### [Patent Literature 1]

Japanese Unexamined Patent Application, First Publication No. 2015-184885

### SUMMARY OF INVENTION

### Technical Problem

The related art is for managing transportation to a service providing place, and is not for managing a service provided within a vehicle.

The present invention was contrived in view of such circumstances, and one object thereof is to provide a service management device, a service providing system, a service management method, and a program which make it possible to suitably manage a service provided by a service provider within a vehicle.

### Solution to Problem

A vehicle control system, a vehicle control method, and a program according to the present invention have the following configurations adopted therein.

(1) According to an aspect of the present invention, there is provided service management device including: an acquisitor that acquires a riding-together request for a service user to request riding together with a service provider within a moving vehicle; and a plan decider that decides a riding-together plan of the service user and the service provider in response to the riding-together request acquired by the acquisitor.

(2) In the aspect of the above (1), the riding-together request includes information of a first boarding section in which the service user boards the vehicle.

(3) In the aspect of the above (2), the service user is a user for whom boarding the vehicle alone is not desirable, and the plan decider decides a second boarding section in which the service provider boards the vehicle so as to include the first boarding section.

(4) In the aspect of the above (2), the plan decider refers to information of an area in which the service provider is able to board the vehicle, and decides a second boarding section in which the service provider boards the vehicle so that the service provider rides together with the service user within a range of an overlap between the first boarding section and the area.

(5) In the aspect of the above (1), the plan decider decides the riding-together plan so that the service user exits a vehicle at a point capable of association with a post-exit service which is received by the service user after exiting.

(6) In the aspect of the above (5), the plan decider executes an online reservation required for the post-exit service.

(7) In the aspect of the above (1), the plan decider selects a service provider according to a type of service designated in advance, and decides a riding-together plan of the service user and the selected service provider.

(8) In the aspect of the above (1), the vehicle is an autonomously driven vehicle having a wireless communication function, and the service management device further includes: a communication unit that communicates with the vehicle; and a route indicator that causes the communication unit to transmit an indication of a route based on the riding-together plan decided by the plan decider to the vehicle.

(9) According to another aspect, there is provided a service providing system including: the service management device according to the aspect of the above (8); and the vehicle, wherein the service management device transmits an estimated time of service provision together with the indication of the route to the vehicle, and the vehicle performs driving control not to arrive at a destination before an elapse of the estimated time of service provision.

(10) According to another aspect of the present invention, there is provided a service management method including causing a computer to: acquire a riding-together request for a service user to request riding together with a service provider within a moving vehicle; and decide a riding-together plan of the service user and the service provider in response to the acquired riding-together request.

(11) According to another aspect of the present invention, there is provided a program causing a computer to: acquire a riding-together request for a service user to request riding together with a service provider within a moving vehicle; and decide a riding-together plan of the service user and the service provider in response to the acquired riding-together request.

(12) According to another aspect of the present invention, there is provided a service management device including: a first acquisitor that acquires service use request information of a service user who uses a service with use of a vehicle; a second acquisitor that acquires vehicle information of a vehicle registered in advance; a vehicle specifier that specifies an available vehicle on the basis of the service use request information and the acquired vehicle information, and generates available vehicle information; a third acquisitor that acquires service provision information related to a service for which a service provider who provides a service with use of a vehicle is able to receive an order; and a plan decider that specifies an available service which is able to be enjoyed by the service user on the basis of the available vehicle information and the service provision information, and provides information on the specified available service to the service user.

(13) In the aspect of the above (12), the service use request information includes information of a first section in which the service user occupies at least a portion of the vehicle.

(14) In the aspect of the above (13), the service use request information includes attribute information of the service provider which is desired by the service user.

(15) In the aspect of the above (13), the service management device further includes a plan decider that sets a second section in which the service provider occupies at least a portion of the vehicle on the basis of the available vehicle information and the service provision information, and sets a third section in which the service user and the service provider occupy at least a portion of the vehicle on the basis of an overlap between the first section and the second section.

(16) In the aspect of the above (13) or (14), the service provision information includes information of a service providable area, and the service management device further includes a plan decider that sets a third section in which the service user and the service provider occupy at least a portion of the vehicle within an overlap range between the first section and the information of the service providable area.

(17) In the aspect of the above (13), the service provision information includes information of a service provision point outside of a vehicle, and the service management device further includes a plan decider that updates the first section so that the first section ends with the service provision point outside of the vehicle in accordance with an indication from the service user.

(18) In the aspect of the above (13), the service management device further includes a determination unit that determines whether both the service user and the service provider use the vehicle, and the plan decider updates the first section in a case where it is determined by the determination unit that both use the vehicle.

(19) In the aspect of the above (17), the service management device further includes a communication unit that transmits reservation information for reserving a facility located at the service provision point outside of the vehicle, and receives a reservation result corresponding to the reservation information.

(20) In the aspect of the above (12), the vehicle is an autonomously driven vehicle having a wireless communication function, and the service management device further includes: a communication unit that communicates with the vehicle; and a route indicator that causes the communication unit to transmit information of a use start position and a use end position of the service user and information of a use start position and a use end position of the service provider to the vehicle.

(21) In the aspect of the above (15) or (16), the service use request information includes information of a service use time slot which is desired by the service user, and the plan decider sets the third section so that a time slot in which the service user occupies at least a portion of the vehicle is coincident with the service use time slot.

(22) In the aspect of the above (21), the service provision information includes information of a service provision time slot which is desired by the service provider, and the plan decider sets the third section so that a time slot in which the service provider occupies at least a portion of the vehicle is coincident with the service provision time slot.

(23) In the aspect of the above (15), in a case where the second section is set to correspond to each of a plurality of services providers, the plan decider sets a plurality of the third sections corresponding to a plurality of the second sections.

(24) In the aspect of the above (12), the service management device further includes: a determination unit that determines whether the service user uses the vehicle at a point in time when the first acquisitor receives the service use request information; and a plan decider that preferentially allocates the vehicle in use to the user in a case where it is determined by the determination unit that the service user uses the vehicle.

(25) According to another aspect of the present invention, there is provided a service management method including causing a computer to: acquire service use request information of a service user who uses a service with use of a vehicle; acquire vehicle information of a vehicle registered in advance; specify an available vehicle on the basis of the service use request information and the acquired vehicle information to generate available vehicle information; acquire service provision information related to a service for which a service provider who provides a service with use of a vehicle is able to receive an order; and specify an available service which is able to be enjoyed by the service user on the basis of the available vehicle information and the service provision information, and provide information on the specified available service to the service user.

(26) According to another aspect of the present invention, there is provided a program causing a computer to: acquire service use request information of a service user who uses a service with use of a vehicle; acquire vehicle information of a vehicle registered in advance; specify an available vehicle on the basis of the service use request information and the acquired vehicle information to generate available vehicle information; acquire service provision information related to a service for which a service provider who provides a service with use of a vehicle is able to receive an order; and specify an available service which is able to be enjoyed by the service user on the basis of the available vehicle information and the service provision information, and provide information on the specified available service to the service user.

### Advantageous Effects of Invention

According to the aspects of (1) to (26), it is possible to suitably manage a service which is provided by a service provider within a vehicle.

According to the aspect of (3), it is possible to suitably transport an infant, an aged person, or the like.

According to the aspect of (4), it is possible to decide a riding-together plan in accordance with a service provider's convenience.

According to the aspect of (6), it is possible to suitably provide a series of services continued until after exiting.

According to the aspect of (7), it is possible to provide various services.

According to the aspect of (12), since vehicle information is acquired from candidates of vehicles registered in advance, and an available vehicle is specified on the basis of the service use request information, it is possible to promote more positive use of a vehicle.

According to the aspect of (17) or (19), a service user continues a service even after exiting a vehicle, and thus it is possible to improve the service user's feeling of satisfaction.

### BRIEF DESCRIPTION OF DRAWINGS

FIG. 1 is a configuration diagram of a service providing system 1 including a service management device.

FIG. 2 is a configuration diagram of a vehicle.

FIG. 3 is a diagram illustrating a process stage of autonomous driving.

FIG. 4 is a diagram illustrating an example of content of a riding-together request list.

FIG. 5 is a diagram illustrating an example of content of service providable range information.

FIG. 6 is a first diagram illustrating a status in which a riding-together plan is decided.

FIG. 7 is a diagram illustrating an example of content of operation schedule information in which the riding-together plan shown in FIG. 6 is reflected.

FIG. 8 is a second diagram illustrating a status in which a riding-together plan is decided.

FIG. 9 is a diagram illustrating an example of content of the operation schedule information in which the riding-together plan shown in FIG. 8 is reflected.

FIG. 10 is a flow chart illustrating an example of a flow of processes which are executed by the service management device.

FIG. 11 is a diagram illustrating an example of a screen IM for inquiring whether content of a riding-together request can be changed.

FIG. 12 is a diagram illustrating a status in which a riding-together plan is decided in a second embodiment.

FIG. 13 is a diagram illustrating an example of content of the operation schedule information in which the riding-together plan shown in FIG. 12 is reflected.

FIG. 14 is a diagram illustrating a status in which a riding-together plan is decided in a third embodiment.

FIG. 15 is a diagram illustrating an example of content of the operation schedule information in which the riding-together plan shown in FIG. 14 is reflected.

FIG. 16 is a diagram illustrating an example of content of a riding-together request list according to a fourth embodiment.

FIG. 17 is a diagram illustrating an example of content of service providable range information of the fourth embodiment.

FIG. 18 is a diagram schematically illustrating content of driving control which is executed by the vehicle.

FIG. 19 is a configuration diagram of a service providing system including a service management device according to a fifth embodiment.

FIG. 20 is a diagram illustrating an example of a configuration of a vehicle management device which is mounted in a vehicle.

FIG. 21 is a diagram illustrating an example of a configuration of a service provider device.

FIG. 22 is a diagram illustrating an example of a configuration of a service management device.

FIG. 23 is a flow chart illustrating an example of a flow of processes which are executed in the service providing system.

### DESCRIPTION OF EMBODIMENTS

Hereinafter, embodiments of a service management device, a service providing system, and a service management method of the present invention will be described with reference to the accompanying drawings. The service management device is a device that manages a service realized by a service user riding together with a service provider within a moving vehicle. This service may mainly indicate riding together itself, or may indicate riding together and some kind of operation being further performed. An example of the former includes a service in which a service provider such as a nursery teacher, a caregiver, or a nurse rides together with a service user for whom boarding a vehicle alone is not desirable (for example, an infant, an aged person, a sick person, or a physically disabled person). Meanwhile, even in the case of indicating riding together itself, it may include performance of a concomitant service such as a service provider taking care of an infant or a baby who is a service user.

A service according to each embodiment is applied by, for example, a riding-together request which is electronically transmitted and received. A person who sends a riding-together request (a service applicant) may be a service user himself or herself, or may be another person (such as a family) In addition, a vehicle which is used in this service is, for example, an autonomously driven vehicle which basically does not require a driving operation. In the following description, an autonomously driven vehicle is used, but a manually driven vehicle may be used.

### First Embodiment

Hereinafter, a first embodiment will be described. In the first embodiment, a service mainly indicates riding together itself, and it is assumed that a service provider is requested to ride together in a vehicle throughout the entire section in which a service user is on board the vehicle.

[Overall Configuration]

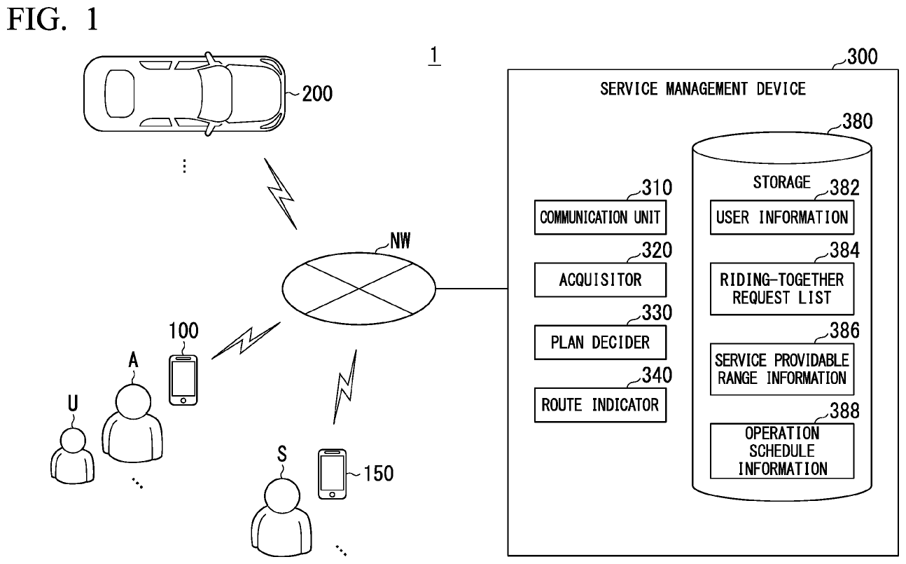

FIG. 1 is a configuration diagram of a service providing system 1 including a service management device 300. The service providing system 1 includes one or more terminal devices 100 which are used by one or more service applicants A, one or more terminal devices 150 which are used by one or more service providers, one or more vehicles 200, and the service management device 300. These components can communicate with one another through a network NW. The network NW includes the Internet, a wide area network (WAN), a local area network (LAN), a public line, a provider device, a dedicated channel, a wireless base station, or the like. A service provided by a service provider S is provided to a service user U. In the drawing, the service applicant A and the service user U are shown like different persons, but they may be the same person. Meanwhile, “used by the service applicant A or the service provider S” may include terminal devices, capable of being used by an unspecified large number of users, such as terminal devices in an Internet cafe being temporarily used by the service applicant A or the service provider S.

[Terminal Device]

The terminal device 100 is, for example, a smartphone, a tablet terminal, a personal computer, or the like. In the terminal device 100, an application program, a browser or the like for using the service providing system 1 is started up, and a service to be described below is supported. In the following description, it is assumed that the terminal device 100 is a smartphone, and that an application program (an application for a service applicant) is started up. The application for a service user communicates with the service management device 300 in accordance with the service applicant A's operation, and transmits a request from the service applicant A to the service management device 300, or performs a push notification based on information received from the service management device 300.

Similarly to the terminal device 100, the terminal device 150 is, for example, a smartphone, a tablet terminal, a personal computer, or the like. In the terminal device 150, an application program, a browser or the like for participating in the service providing system 1 is started up, and a service to be described below is supported. In the following description, it is assumed that the terminal device 150 is a smartphone, and that an application program (an application for a service provider) is started up. The application for a service provider communicates with the service management device 300 in accordance with the service provider S's operation, and transmits acceptance information of the service provider S to the service management device 300, or performs a push notification based on information received from the service management device 300.

[Vehicle]

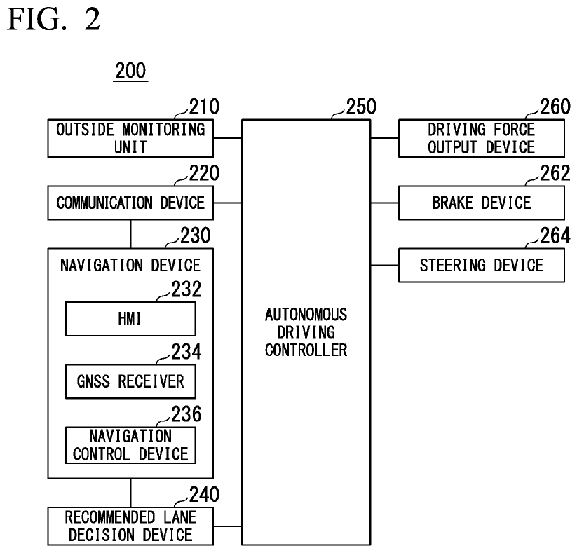

The vehicle 200 is a vehicle including at least a vehicle interior. FIG. 2 is a configuration diagram of the vehicle 200. The vehicle 200 includes, for example, an outside monitoring unit 210, a communication device 220, a navigation device 230, a recommended lane decision device 240, an autonomous driving controller 250, a driving force output device 260, a brake device 262, and a steering device 264.

The outside monitoring unit 210 includes, for example, a camera, a radar, a light detection and ranging (LIDAR) sensor, an object recognition device that performs a sensor fusion process on the basis of the outputs thereof, or the like. The outside monitoring unit 210 estimates the type of object (particularly, a vehicle, a pedestrian, and a bicycle) present in the vicinity of the vehicle 200, and outputs the estimated type to the autonomous driving controller 250 together with information on the position or speed.

The communication device 220 is, for example, a wireless communication module for connection to the network NW or direct communication with another vehicle, a pedestrian's terminal device, or the like. The communication device 220 performs wireless communication on the basis of Wi-Fi, dedicated short range communications (DSRC), Bluetooth (registered trademark), or another communication standard. As the communication device 220, a plurality of devices for its use may be prepared.

The navigation device 230 includes, for example, a human machine interface (HMI) 232, a global navigation satellite system (GNSS) receiver 234, and a navigation control device 236. The HMI 232 includes, for example, a touch panel-type display device, a speaker, a microphone, or the like. The GNSS receiver 234 measures its position (the position of the vehicle 200) on the basis of radio waves arriving from a GNSS satellite (for example, a GPS satellite). The navigation control device 236 includes, for example, a central processing unit (CPU) or various storage devices, and controls the entirety of the navigation device 230. Map information (a navigation map) is stored in the storage device. The navigation map is a map in which roads are represented using nodes and links. The navigation control device 236 refers to the navigation map to decide a route to a destination designated using the HMI 232 from the position of the vehicle 200 measured by the GNSS receiver 234. In addition, the navigation control device 236 may transmit the position of the vehicle 200 and the destination to a navigation server (not shown) using the communication device 220, and acquire a route sent back from the navigation server. In addition, in the present example, a route to a destination may be designated by the service management device 300. Meanwhile, the route may include information on an arrival target time and a point at which a vehicle stops in order to allow a user to board or exit the vehicle. The navigation control device 236 outputs information on the route decided using any of the foregoing methods to the recommended lane decision device 240.

The recommended lane decision device 240 includes, for example, a micro processing unit (MPU) and various storage devices. High-accuracy map information which is more detailed than the navigation map is stored in the storage device. The high-accuracy map information includes, for example, information such as a road width or gradient for each lane, curvature, or the position of a signal. The recommended lane decision device 240 decides a preferred recommended lane in order to travel along a route which is input from the navigation device 230, and outputs the decided recommended lane to the autonomous driving controller 250.

The autonomous driving controller 250 includes one or more processors such as a CPU or an MPU and various storage devices. The autonomous driving controller 250 causes the vehicle 200 to travel autonomously while avoiding contact with an object of which the position or speed is input from the outside monitoring unit 210 with travel in the recommended lane decided by the recommended lane decision device 240 as a principle. The autonomous driving controller 250 sequentially executes, for example, various events. Examples of the events include a constant-speed traveling event of traveling in the same traveling lane at a constant speed, a following traveling event of following a preceding vehicle, a lane change event, a merging event, a divergence event, an emergency stop event, a tollbooth event for passing a tollbooth, a handover event for terminating autonomous driving and switching to manual driving, and the like. In addition, during execution of these events, behavior for avoidance may be planned on the basis of the surrounding situation (such as the presence of a nearby vehicle or pedestrian or lane narrowing caused by road construction) of the vehicle 200.

The autonomous driving controller 250 generates a target trajectory along which the vehicle 200 will travel in the future. The target trajectory includes, for example, a speed element. For example, the target trajectory is represented as points (trajectory points), lined up in order, to be reached by a host vehicle M. A trajectory point is a point to be reached by the host vehicle M for each predetermined traveling distance, and aside from this, target speed and target acceleration for each predetermined sampling time (for example, approximately several tenths of a [sec]) are generated as a portion of the target trajectory. In addition, the trajectory point may be a position, for each predetermined sampling time, to be reached by the host vehicle M at the sampling time. In this case, information of the target speed or the target acceleration is represented by an interval between trajectory points.

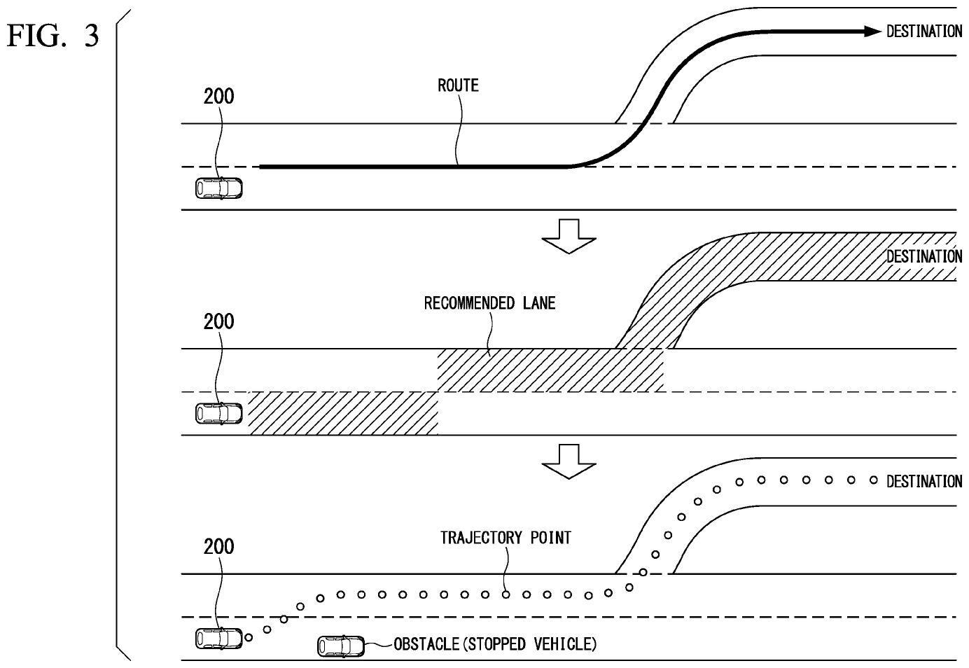

FIG. 3 is a diagram illustrating a process stage of autonomous driving. First, as shown in the upper diagram, a route is decided by the navigation device 230. This route is, for example, a rough route in which lanes are not distinguished from each other. Next, as shown in the middle diagram, the recommended lane decision device 240 decides a recommended lane in which a vehicle has a tendency to travel along a route. As shown in the lower diagram, the autonomous driving controller 250 generates trajectory points for traveling along a recommended lane if possible while avoiding obstacles or the like, and controls some or all of the driving force output device 260, the brake device 262, and the steering device 264 to travel along the trajectory points (and an associated speed profile). Meanwhile, such sharing of roles is merely an example, and, for example, the autonomous driving controller 250 may centrally perform a process.

The driving force output device 260 outputs a traveling drive force (torque) for a vehicle to travel to a driving wheel. The driving force output device 260 includes, for example, a combination of an internal-combustion engine, an electric motor, a transmission or the like, and a power ECU that controls these components. The power ECU controls the above components in accordance with information which is input from the autonomous driving controller 250 or information which is input from a driving operator (not shown).

The brake device 262 includes, for example, a brake caliper, a cylinder that transfers hydraulic pressure to the brake caliper, an electric motor that generates hydraulic pressure in the cylinder, and a brake ECU. The brake ECU controls the electric motor in accordance with the information which is input from the autonomous driving controller 250 or the information which is input from the driving operator, and causes a brake torque according to a braking operation to be output to each wheel. The brake device 262 may include a mechanism that transfers hydraulic pressure generated by the operation of a brake pedal included in the driving operator through a master cylinder to the cylinder as a backup. Meanwhile, the brake device 262 is not limited to the above-described configuration, and may be an electronic control type hydraulic pressure brake device that controls an actuator in accordance with the information which is input from the autonomous driving controller 250 and transfers hydraulic pressure of the master cylinder to the cylinder.

The steering device 264 includes, for example, a steering ECU and an electric motor. The electric motor changes the direction of a turning wheel, for example, by causing a force to act on a rack and pinion mechanism. The steering ECU drives the electric motor in accordance with the information which is input from the autonomous driving controller 250 or the information which is input from the driving operator, and changes the direction of the turning wheel.

[Service Management Device]

Referring back to FIG. 1, the service management device 300 includes, for example, a communication unit 310, an acquisitor 320, a plan decider 330, a route indicator 340, and a storage 380.

The communicator 310 is, for example, a network card for connection to the network NW. In addition, the storage 380 is realized by a hard disk drive (HDD), a flash memory, a random access memory (RAM), a read only memory (ROM), or the like. The communication unit 310 communicates with the terminal devices 100 and 150 or the vehicle 200 through the network NW.

The acquisitor 320, the plan decider 330, and the route indicator 340 are realized, for example, by a processor such as a CPU executing a program (software) stored in the storage 380. In addition, some or all of these functional units may be realized by hardware such as a large scale integration (LSI), an application specific integrated circuit (ASIC), or a field-programmable gate array (FPGA), or may be realized by software and hardware in cooperation.

The acquisitor 320 acquires a riding-together request issued from the terminal device 100 of the service applicant A through the communication unit 310 and the network NW, and registers the acquired riding-together request as a riding-together request list 384 with the storage 380. In addition, the acquisitor 320 acquires a service providable range notification issued from the terminal device 150 of the service provider S through the communication unit 310 and the network NW, and registers the acquired service providable range notification as service providable range information 386 with the storage 380. Meanwhile, user information 382 includes personal information or the like of the service applicant A, the service user U, and the service provider S.

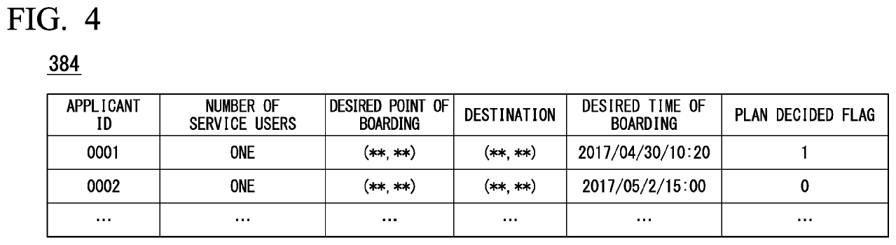

FIG. 4 is a diagram illustrating an example of content of the riding-together request list 384. As shown in the drawing, the riding-together request list 384 is information in which the number of service users, a desired point of boarding, a destination, a desired time of boarding, a plan decided flag indicating whether a plan is decided (for example, 1 indicates that a plan is decided, and 0 indicates that a plan is undecided), or the like is associated with an applicant ID which is identification information of the service applicant A registered in advance. Information other than the plan decided flag has its content decided by a service application of the terminal device 100 accepting the service applicant A's input, and is transmitted to the service management device 300 as a riding-together request. A section from a desired point of boarding to a destination is an example of a “first boarding section.” Hereinafter, a series of information associated with one user ID in the riding-together request list 384 may be referred to as a record. Meanwhile, the riding-together request is not required to be performed in every use, and a plurality of riding-together requests may be performed collectively. For example, an application such as a desire for a riding-together service from a desired point of boarding to a destination at fixed times on weekdays every week may be performed.

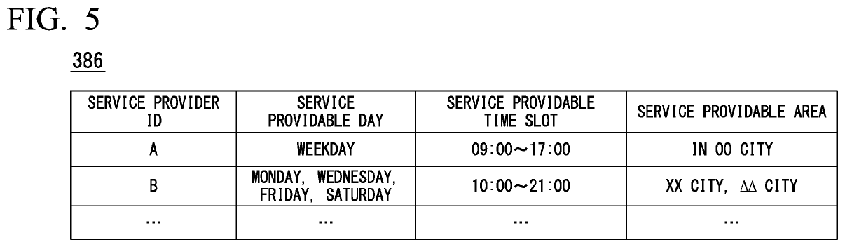

FIG. 5 is a diagram illustrating an example of content of the service providable range information 386. As shown in the drawing, the service providable range information 386 is information in which a service providable day, a service providable time slot, a service providable area, or the like is associated with a service provider ID which is identification information of the service provider S registered in advance.

The plan decider 330 decides a riding-together plan of the service user U and the service provider S in response to the riding-together request registered with the riding-together request list 384. The plan decider 330 of the first embodiment decides a section in which the service provider S boards the vehicle 200 (a second boarding section) so as to include a section from a desired section of boarding to a destination in the riding-together request.

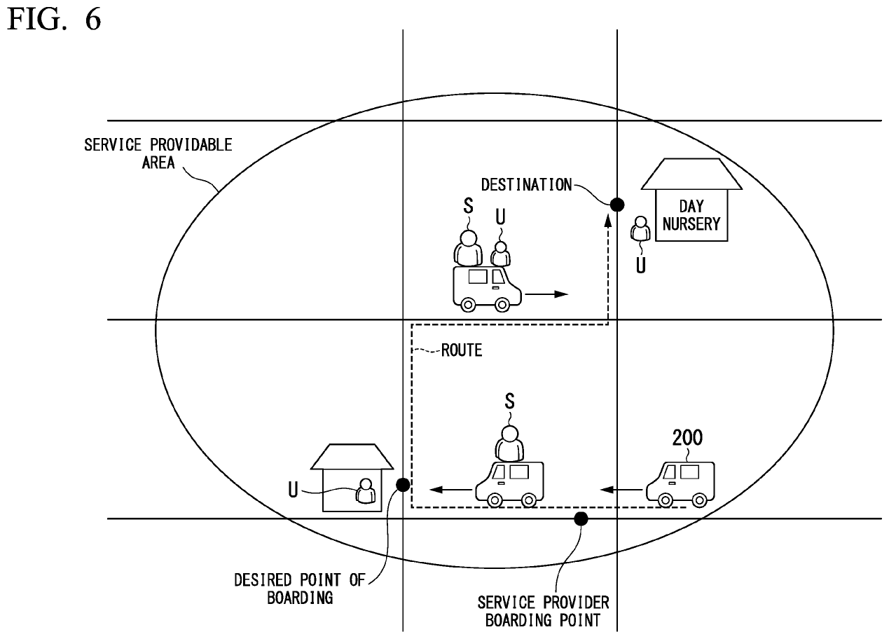

FIG. 6 is a first diagram illustrating a status in which a riding-together plan is decided. The riding-together plan is set in a case where conditions such as both a desired point of boarding and a destination falling within a service providable area and a period obtained by adding an assumed driving time to a desired time of boarding falling within a service providable time slot are met. At the desired point of boarding of the service user U, the service provider S is already on board the vehicle 200, and the vehicle 200 moves on to a desired place after the service user U is dropped off at a destination. A day nursery or the like is at the destination.

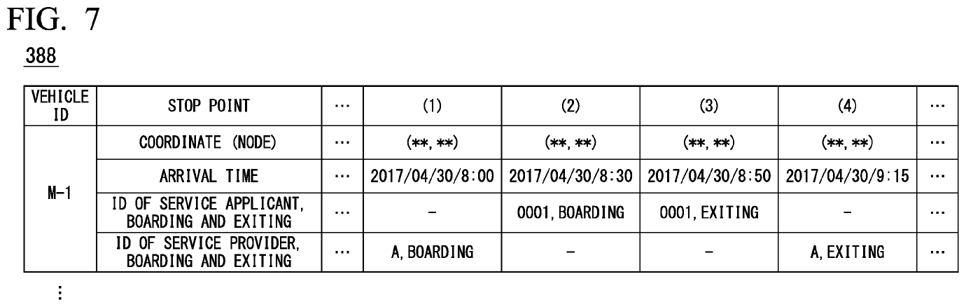

FIG. 7 is a diagram illustrating an example of content of operation schedule information 388 in which the riding-together plan shown in FIG. 6 is reflected. As shown in the drawing, the service provider S whose service provider ID is “A” boards a vehicle at a stop point (1), the service user U corresponding to a service applicant whose applicant ID is “0001” boards the vehicle at a stop point (2) equivalent to a desired point of boarding, and the service user U exits the vehicle at a stop point (3) which is a destination and enters a day nursery. The vehicle 200 carrying the service provider S moves to a place where the service user U waits for the purpose of the next service, or sends the service provider S home.

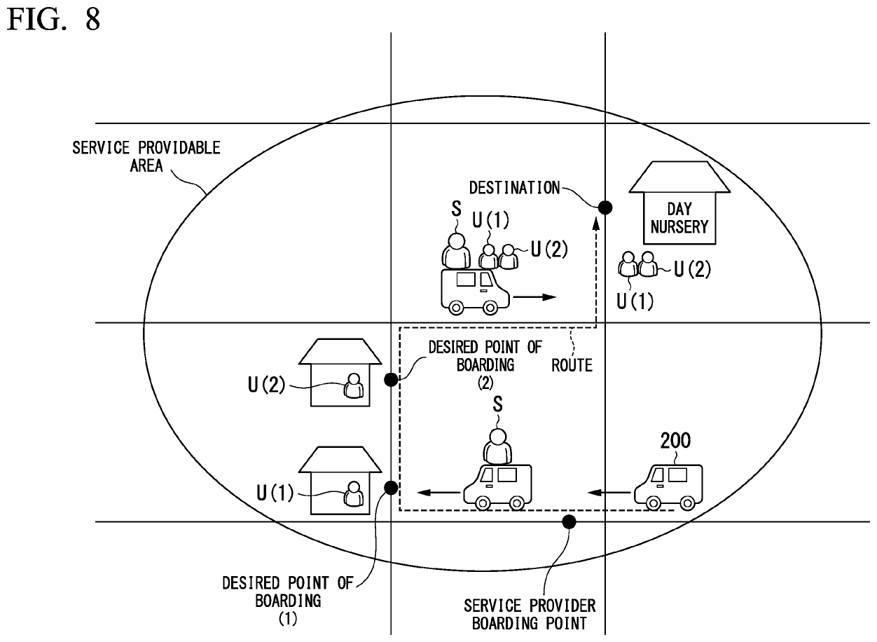

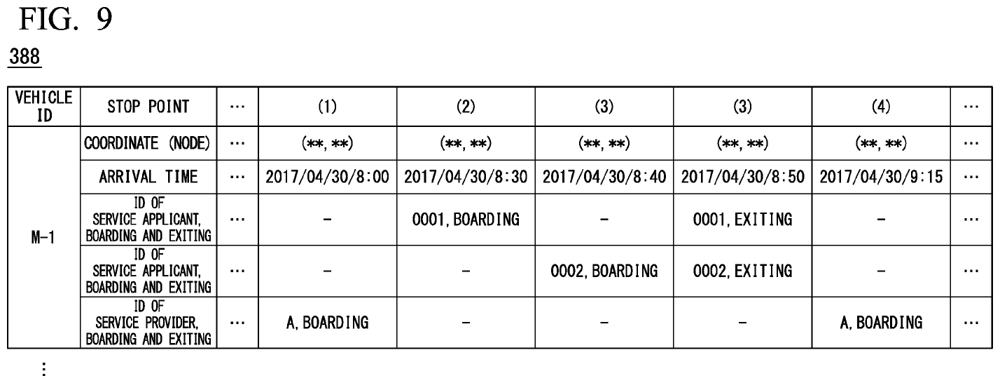

Here, one service provider S may ride together with a plurality of services users U. In this case, a riding-together plan is decided as shown in FIG. 8, and the operation schedule information 388 is decided as shown in FIG. 9. FIG. 8 is a second diagram illustrating a status in which a riding-together plan is decided. FIG. 9 is a diagram illustrating an example of content of the operation schedule information 388 in which the riding-together plan shown in FIG. 8 is reflected. In the shown example, a service user U(1) corresponding to a service applicant A whose applicant ID is “0001” first boards the vehicle 200 that the service provider S boards, a service user U(2) corresponding to a service applicant A whose applicant ID is “0002” boards the vehicle, and the service users U(1) and U(2) exit the vehicle at the same destination. In this manner, in a case where sections from desired points of boarding of a plurality of users U to their destinations are included within a section in which the service provider S boards the vehicle 200, the plan decider 330 may decide a riding-together plan so that one service provider S rides together with a plurality of services users U.

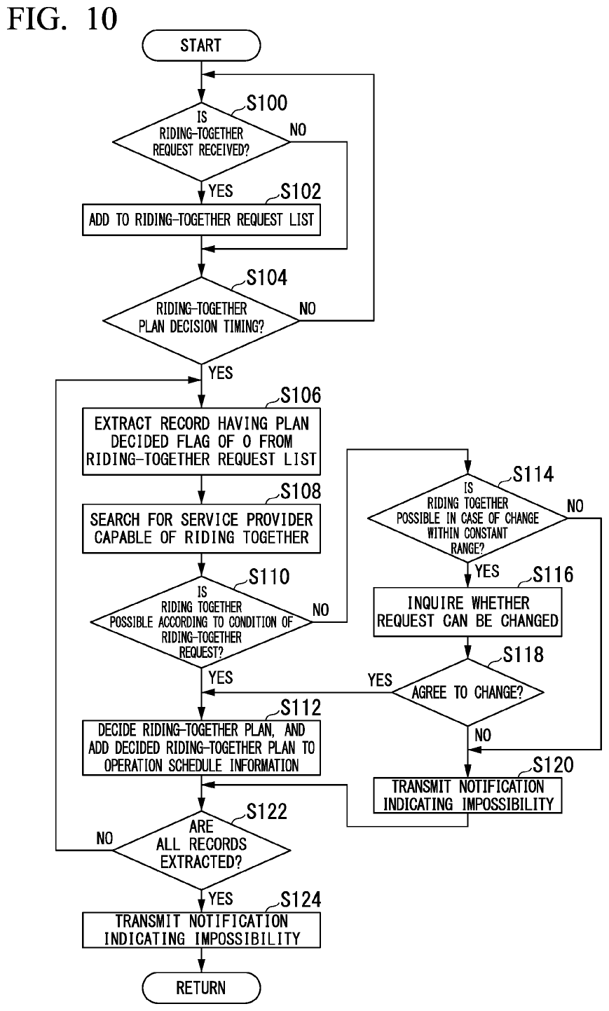

FIG. 10 is a flow chart illustrating an example of a flow of processes which are executed by the service management device 300. First, the service management device 300 determines whether a riding-together request has been received from the terminal device 100 (step S100). In a case where the riding-together request is received from the terminal device 100, the service management device 300 adds content included in the riding-together request to the riding-together request list 384 (step S102).

Next, the service management device 300 determines whether a riding-together plan decision timing has arrived (step S104). In a case where the riding-together plan decision timing has not arrived, the process is returned to step S100. The riding-together plan decision timing can be set arbitrarily, but is set to arrive at intervals of a predetermined time (for example, about 10 minutes), for example, during business hours of the service providing system 1, or the like.

In a case where the riding-together plan decision timing has arrived, the service management device 300 extracts a record having a plan decided flag of 0 from the riding-together request list 384 (step S106). Next, the service management device 300 refers to the service providable range information 386, and searches for a service provider S capable of riding together according to a condition of the riding-together request (step S108).

Next, the service management device 300 determines whether the service provider S capable of riding together is present according to a condition of the riding-together request (step S110). In a case where the service provider S capable of riding together is present according to a condition of the riding-together request, the service management device 300 decides a riding-together plan of a service user U corresponding to a record extracted in step S106, and adds the decided riding-together plan to the operation schedule information 388 (step S112). In this case, the service management device 300 changes a plan decided flag in the extracted record to 1.

On the other hand, in a case where the service provider S capable of riding together is not present according to a condition of the riding-together request, the service management device 300 determines whether the service provider S capable of riding together is present when the condition of the riding-together request is changed within a constant range (step S114). Here, the wording “within a constant range” is, for example, about several tens of [h] in terms of time, and is, for example, about several hundreds of [m] in terms of a place.

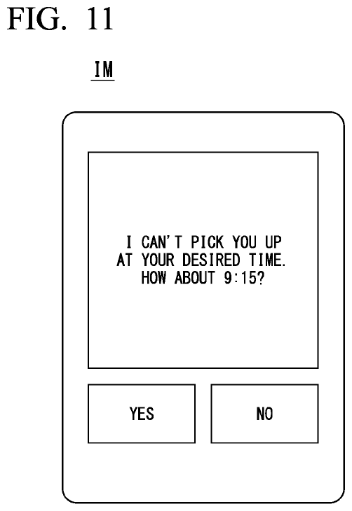

In a case where an affirmative determination is obtained in step S114, the service management device 300 causes the communication unit 310 to transmit information for inquiring whether content of the riding-together request can be changed to the terminal device 100 (step S116). Receiving this, in the terminal device 100, a screen for inquiring whether the content of the riding-together request can be changed is displayed. FIG. 11 is a diagram illustrating an example of a screen IM for inquiring whether the content of the riding-together request can be changed. In the screen IM, the effect that arrival is not possible at a desired time of boarding and information of an alternative time at which arrival is possible are displayed, and a YES button and a NO button for indicating whether to agree to a time change are further set. In a case where either button is operated by a user, the service application of the terminal device 100 transmits information indicating operation content to the service management device 300. Meanwhile, the same is true of a place change.

Referring back to FIG. 10, the service management device 300 determines whether the service applicant A's agreement to change is obtained on the basis of content received from the terminal device 100 (step S118). The service management device 300 determines that the agreement is obtained in a case where the YES button is operated in the terminal device 100, and determines that the agreement is not obtained in a case where the NO button is operated.

In a case where the agreement to change is obtained, the service management device 300 decides a riding-together plan of a service user U corresponding to a record extracted in step S106 in changed content, and adds the decided riding-together plan to the operation schedule information 388 (step S112). In this case, the service management device 300 changes a plan decided flag in the extracted record to 1. On the other hand, in a case where the agreement to change is not obtained, or a case where a negative determination is obtained in step S114, the service management device 300 transmits a notification indicating the impossibility to respond to the riding-together request at this time (a notification of impossibility) to the terminal device 100 by controlling the communication unit 310 (step S120). In this case, the service management device 300 may delete the extracted record, or may perform a search at the next riding-together plan decision timing again.

In a case where the processes of steps S110 to S120 are terminated, the service management device 300 determines whether records corresponding to all the service applicants A have been extracted (step S122). In a case where the records corresponding to all the service applicants A have not been extracted, the process is returned to step S106. In a case where the records corresponding to all the service applicants A have been extracted, the route indicator 340 of the service management device 300 transmits an operation schedule added or updated in a process at this time to the vehicle 200 (step S124). Meanwhile, in a case where a manually driven vehicle is used, the service management device 300 notifies a terminal device of a driver of the vehicle or an in-vehicle terminal device of a request for a change of a boarding request.

According to the first embodiment described above, it is possible to suitably manage a service which is provided by a service provider within a vehicle.

### Second Embodiment

Hereinafter, a second embodiment will be described. Regarding a configuration diagram or a basic function of each device, FIGS. 1 to 5 and related description thereof will be quoted. In the second embodiment, a service is assumed to be executed after riding together in a vehicle. For example, any service provided by the service provider S such as language education, a haircut, a massage, or assistance with legal procedures is provided within the vehicle 200.

Therefore, in the second embodiment, the service provider S does not have to ride together in a vehicle throughout the entire section in which the service user U is on board the vehicle. In addition, the service user U himself or herself is mainly assumed to become the service applicant A. The plan decider 330 of the second embodiment decides a section in which the service provider S boards the vehicle 200 (a second boarding section) within a range which is specified by the service providable range information 386.

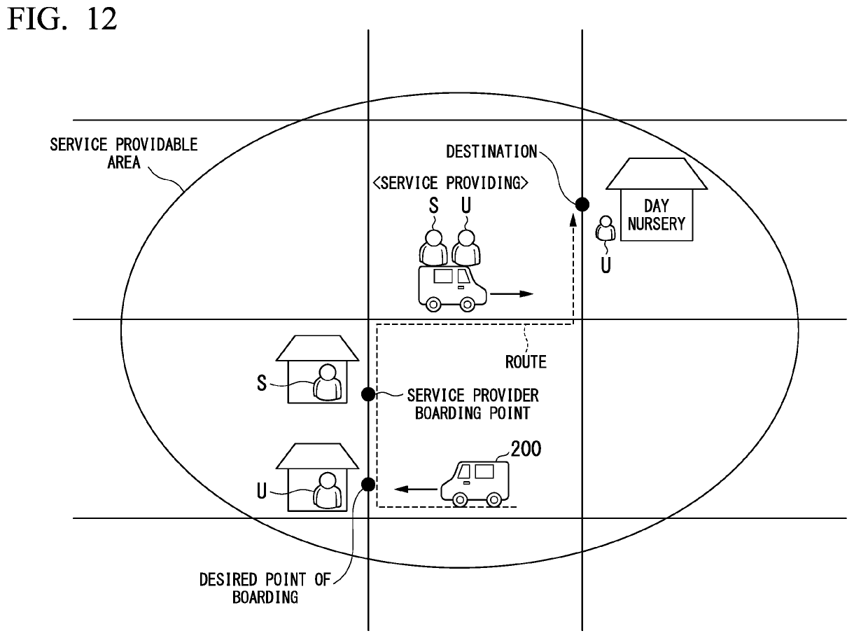

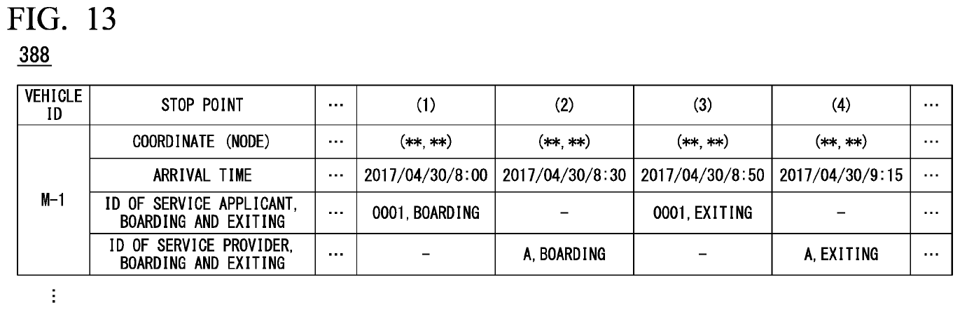

FIG. 12 is a diagram illustrating a status in which a riding-together plan is decided in the second embodiment. As shown in the drawing, the service provider S may board the vehicle 200 in a state in which the service user U is already on board. The service user U goes to his or her company, for example, while receiving language education from the service provider S on his or her way to work using the vehicle 200. FIG. 13 is a diagram illustrating an example of content of the operation schedule information 388 in which the riding-together plan shown in FIG. 12 is reflected.

According to the second embodiment described above, it is possible to suitably manage a service which is provided by a service provider within a vehicle.

### Third Embodiment

Hereinafter, a third embodiment will be described. Regarding a configuration diagram or a basic function of each device, FIGS. 1 to 5 and related description thereof will be quoted. In the third embodiment, a service is not completed within the vehicle 200, and is continued even within a facility located at a point where the service user U exits the vehicle. Hereinafter, a service performed on board is referred to as an on-board service, and a service provided after exiting is referred to as a post-exit service. In the third embodiment, a destination in a riding-together request is set at a point where a post-exit service is received. The service provider S who performs an on-board service and a service provider S # who performs a post-exit service may be the same person, or may be different persons. In the case of the former, the plan decider 330 decides a boarding plan in which the service provider S exits a vehicle at a destination together with the service user U. Hereinafter, this is set forth as a premise.

A series of services to be provided is, for example, assistance of procedures at the time of purchase of a land. In this case, a series of services of the service provider S explaining procedures within the vehicle 200 and stopping by a real estate office after exiting to perform procedures of signature, seal and the like is provided. In a case where a reservation is required at a facility used by the service provider S at a destination, the plan decider 330 may automatically perform an online reservation.

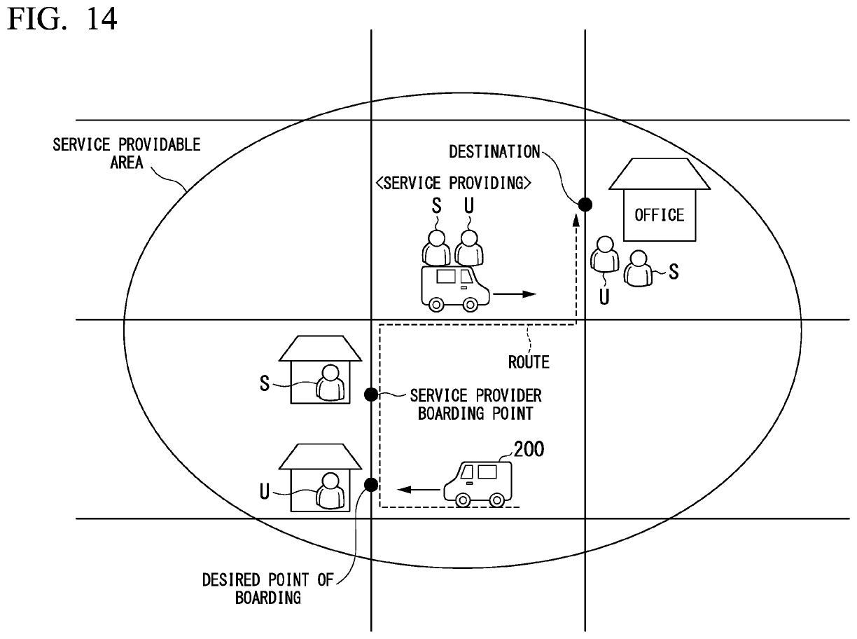

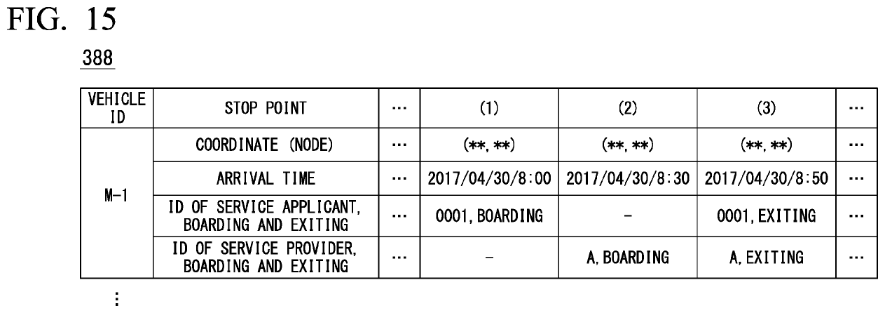

FIG. 14 is a diagram illustrating a status in which a riding-together plan is decided in the third embodiment. The service user U and the service provider S go to a real estate office which is a destination while riding together in a vehicle and explaining procedures, and exit the vehicle together. Procedures of signature, seal and the like are performed at the real estate office. FIG. 15 is a diagram illustrating an example of content of the operation schedule information 388 in which the riding-together plan shown in FIG. 14 is reflected.

According to the third embodiment described above, it is possible to suitably manage services which are provided within a vehicle and after exiting.

### Fourth Embodiment

Hereinafter, a fourth embodiment will be described. Regarding a configuration diagram or a basic function of each device, FIGS. 1 to 5 and related description thereof will be quoted. In the fourth embodiment, the service management device 300 manages a plurality of services. The service user U (or the service applicant A) can select and receive a desired service from among a plurality of services.

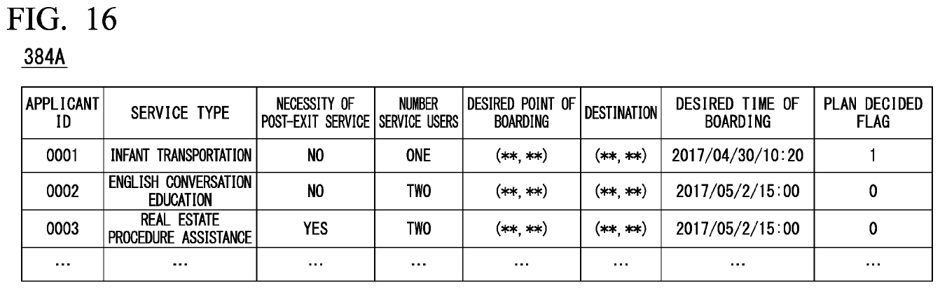

FIG. 16 is a diagram illustrating an example of content of a riding-together request list 384A according to the fourth embodiment. A service type, the necessity of a post-exit service, and the like are added to a riding-together request in the fourth embodiment. The necessity of a post-exit service may be automatically supplemented in the service management device 300 in a case where the service type is designated. Meanwhile, the service type or the necessity of a post-exit service is not designated for each riding-together request, and in a case where a certain service applicant A makes a decision of requesting only a specific service type, the service type or the necessity of a post-exit service may be automatically decided from the service applicant A.

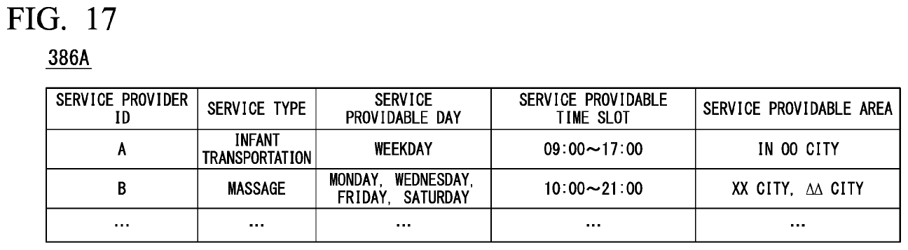

FIG. 17 is a diagram illustrating an example of content of service providable range information 386A according to the fourth embodiment. A service provider S in the fourth embodiment preliminarily declares the type of service capable of being provided by the service provider. The service management device 300 accepts this declaration and registers the accepted declaration with the service providable range information 386A.

The plan decider 330 according to the fourth embodiment executes processes equivalent to step S104 of FIG. 10 and the subsequent steps for each service type. Thereby, the service provider S can be allocated to the service user U for each type of service.

According to the fourth embodiment described above, it is possible to selectively provide various services.

<Control of Autonomously Driven Vehicle>

In the respective embodiments described above (particularly, in the second to fourth embodiments), the vehicle 200 may perform driving control for adjusting a required time which will be taken to arrive at a destination in accordance with a time scheduled for service provision. For example, a riding-together request includes information of a time at which service provision is desired, and an operation schedule which is transmitted from the route indicator 340 to the vehicle 200 includes an estimated time of service provision.

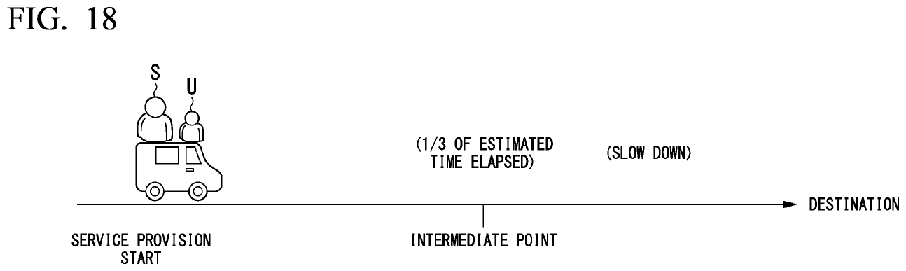

FIG. 18 is a diagram schematically illustrating content of driving control which is executed by the vehicle 200. For example, when arriving at a reference point such as an intermediate point to a destination, the autonomous driving controller 250 of the vehicle 200 compares the time elapsed until then with an estimated time. In a case where the elapsed time is shorter than an expected time which will elapse in traveling to a reference point, arrival at a destination is delayed by retarding the remaining movement process, stopping at a predetermined point, or the like. Thereby, it is possible to secure a sufficient service provision time.

### Fifth Embodiment

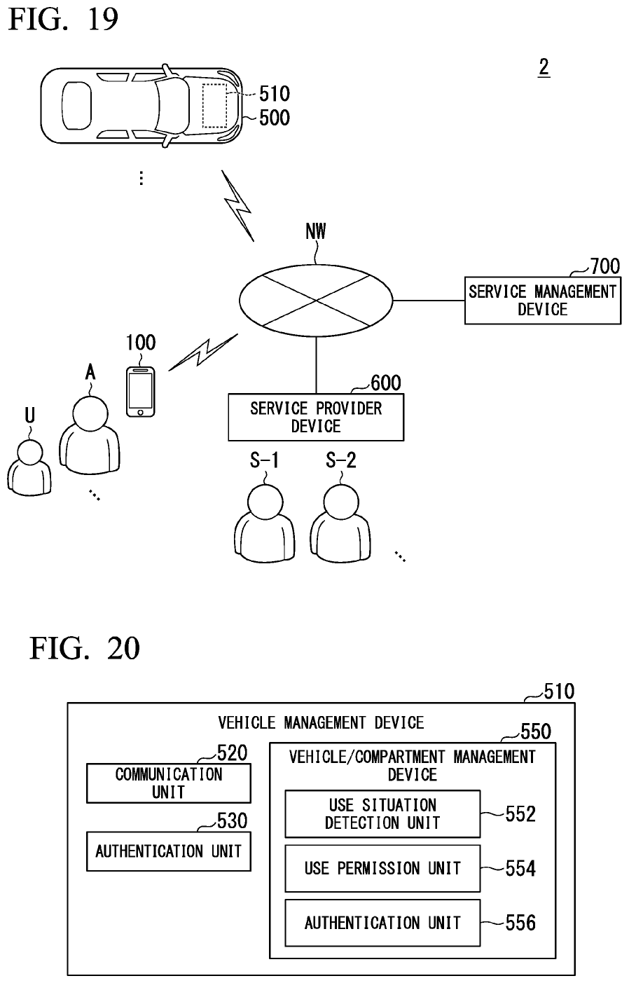

Hereinafter, a fifth embodiment will be described. FIG. 19 is a configuration diagram of a service providing system 2 including a service management device 700 according to the fifth embodiment. The service providing system 2 includes one or more terminal devices 100 which are used by one or more service applicants A, one or more vehicles 500, one or more terminal devices 150 which are used by one or more service providers S, a service provider device 600, and the service management device 700. These components can communicate with one another through a network NW. A service provided by the service provider S is provided to a service user U. In the drawing, the service applicant A and the service user U are shown like different persons, but they may be the same person. Meanwhile, “used by the service applicant A” may include terminal devices, capable of being used by an unspecified large number of users, such as terminal devices in an Internet cafe being temporarily used by the service applicant A.

[Terminal Device]

The hardware and basic function of the terminal device 100 are the same as those in the first embodiment. In the terminal device 100, an application program, a browser or the like for using the service providing system 2 is started up, and a service to be described below is supported. In the following description, it is assumed that the terminal device 100 is a smartphone, and that an application program (an application for a service applicant) is started up. The application for a service user communicates with the service management device 700 in accordance with the service applicant A's operation, and transmits a request from the service applicant A to the service management device 700, or performs a push notification based on information received from the service management device 700.

The terminal device 100 transmits, for example, service use request information including the following content to the service management device 700. Position information is measured by, for example, a GPS receiver which is built into the terminal device 100. Other information is based on information which is input by the service applicant A or the service user U in principle. Desired service provider attribute information is information on an attribute of the service provider S which is desired by the service user U. The attribute may include age, sex, personality (type), or the like in addition to the type of service to be provided. Regarding the attribute, the service management device 700 does not fixedly allocate a service provider S which is in complete accord, and may present a service provider to the service user U to select or settle the service provider.

[Service Use Request Information]
User ID
position information (latitude, longitude, or altitude)
Desired space information (represented by, for example, the number of persons, the number of seats, or the like)
Desired service provider attribute information
Desired service ID
Desired section information (information of a first section)
Information on a time slot of service use which is desired by a service user
Settlement authentication information

[Vehicle]

Components related to traveling control of a vehicle 500 (for example, components related to autonomous driving) are the same as the components included in the vehicle 200 in the first embodiment. That is, the vehicle 500 is an autonomously driven vehicle, and is a vehicle having a wireless communication function as will be described below. FIG. 20 is a diagram illustrating an example of a configuration of a vehicle management device 510 which is mounted in the vehicle 500. The vehicle management device 510 includes, for example, a communication unit 520, an authentication unit 530, and a vehicle/compartment management unit 550.

The communication unit 520 is a wireless communication device. The communication unit 520 communicates with the service management device 700 through the network NW. The authentication unit 530 performs an authentication process for service start in accordance with an indication of the service management device 700.

The vehicle/compartment management device 550 includes, for example, a use situation detection unit 552, a use permission unit 554, and an authentication unit 556. The vehicle 500 is provided with one or more spaces (compartments) available to the service user U or the service provider S, and the use situation detection unit 552 detects a use situation for each compartment. For example, the use situation detection unit 552 detects whether each compartment is in use. In FIG. 20, an ordinary automobile appears as the vehicle 500, but the vehicle 500 may be a vehicle, such as a trailer, a bus, or a microbus, which has as large a size as one or more occupants can board each compartment obtained by delimiting a vehicle interior. For example, in a case where authentication performed by the authentication unit 556 is successful, the use permission unit 554 permits using a compartment designated in advance, and performs, for example, unlocking of a door or the like. The authentication unit 556 performs authentication such as identity verification of the service user U or the service provider S on board.

The vehicle management device 510 transmits, for example, vehicle information including the following content to the service management device 700.

[Vehicle information]
Vehicle ID
Position information (latitude, altitude, or longitude)
Compartment use situation (such as information a user ID of a service user in use with respect to a compartment in use or an available compartment)
Traveling condition (such as speed, acceleration, angular velocity, or a state of a vehicle-mounted device)
Information on the service provider S (such as an ID of a service provider, information of a service in execution, or a service execution elapsed time)

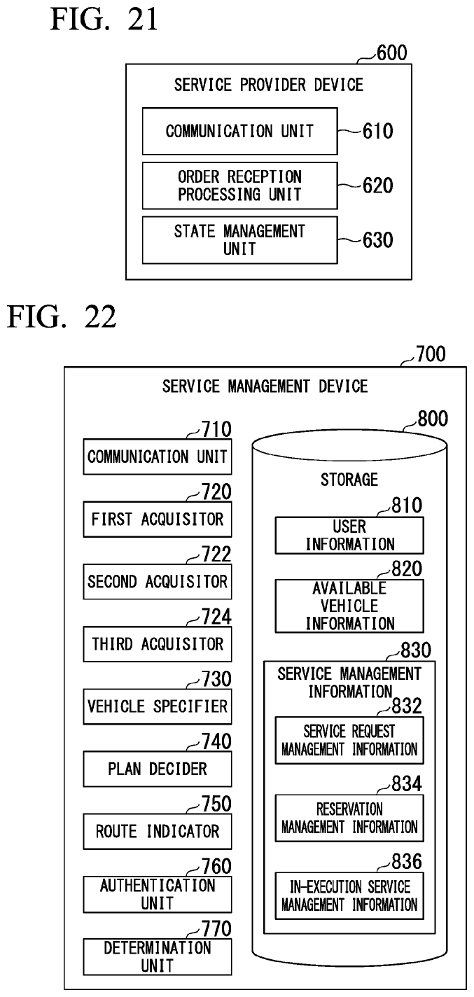

FIG. 21 is a diagram illustrating an example of a configuration of the service provider device 600. The service provider device 600 is, for example, device that ascertains the states of a plurality of services providers and is capable of automatic response to ordering from the service management device 700. The service provider device 600 includes, for example, a communication unit 610, an order reception processing unit 620, a state management unit 630, and a storage 650.

The communication unit 610 communicates with the service management device 700 or the like through the network NW. The order reception processing unit 620 performs order reception processing with respect to the service ordering from the service management device 700. The order reception processing unit 620 determines whether content of the service ordering is within a range of service provision information already transmitted to the service management device 700, and first advances the order reception processing in a case where it is determined to be within the range. The state management unit 630 manages the state (the reservation state, the operating state or the like) of the service provider S registered with the service provider device 600, and provides the service provision information to the service management device 700.

The service provider device 600 transmits, for example, service provision information including the following content to the service management device 700. The service provision information is information related to a service for which the service provider S is able to receive an order.

[Service Provision Information]
Order reception ID
Service name
Execution responsible person information
Service provider attribute information
Information of a service provision time slot which is desired by a service provider
Required vehicle compartment information
Information of a service providable area
Facility point information (service provision point information outside of a vehicle)
Service status

[Service Management Device]

FIG. 22 is a diagram illustrating an example of a configuration of the service management device 700. The service management device 700 includes, for example, a communication unit 710, a first acquisitor 720, a second acquisitor 722, a third acquisitor 724, a vehicle specifier 730, a plan decider 740, a route indicator 750, an authentication unit 760, a determination unit 770, and a storage 800. Components except the communication unit 710 and the storage 800 are realized by a hardware processor such as, for example, a CPU executing a program (software). Some or all of these components may be realized by hardware (a circuit unit; including circuitry) such as an LSI, an ASIC, an FPGA, or a GPU, or may be realized by software and hardware in cooperation. The program may be stored in a storage device such as an HDD or a flash memory in advance, may be stored in a detachable storage medium such as a DVD or a CD-ROM, or may be installed by the storage medium being mounted in a drive device. The storage 800 is realized by an HDD, a flash memory, a RAM, a ROM, or the like.

The communication unit 710 is, for example, a network card for connection to the network NW. The communication unit 710 communicates with the terminal device 100, the vehicle management device 510, the service provider device 600, or the like through the network NW.

The first acquisitor 720 acquires service use request information from the terminal device 100 through the communication unit 710. The second acquisitor 722 acquires vehicle information from the vehicle management device 510 of the vehicle 500 registered in advance through the communication unit 710. The third acquisitor 724 acquires service provision information from the service provider terminal 600 through the communication unit 710.

The vehicle specifier 730 specifies an available vehicle 500 on the basis of the service use request information and the vehicle information, and generates available vehicle information 820. Specifically, the vehicle specifier 730 compares desired space information, desired section information, and information on a time slot of service use which are included in the service use request information with position information and compartment use situation which are included in the vehicle information, and specifies a vehicle satisfying a condition in which the position information and the compartment use situation are included in the service use request information as the available vehicle 500.

The plan decider 740 specifies an available service which is able to be enjoyed by the service user U on the basis of the available vehicle information 820 and the service provision information, and provides information on the specified available service to the terminal device 100 of the service user U.

More specifically, the plan decider 740 sets a second section in which the service provider S occupies at least a portion of the vehicle 500 (for example, a compartment) on the basis of the available vehicle information 820 and the service provision information, and sets a third section in which the service user U and the service provider S occupy at least a portion of the vehicle 500 on the basis of an overlap between the second section and the desired section information (information of the first section) in the service use request information. Meanwhile, in a case where the service provider S is already on board the vehicle 500 before the setting of the first section, the plan decider 740 may set the second section with the current position of the vehicle 500 as a starting point simultaneously with the setting of the first section.

In addition, the plan decider 740 sets a third section within an overlap range between the first section and the information of a service providable area included in the service provision information. Further, the plan decider 740 sets the third section so that a time slot in which the service user U occupies at least a portion of the vehicle 500 is coincident with information of a service use time slot which is desired by the service user, and that a time slot in which a service provider occupies the vehicle is coincident with information of a service provision time slot which is desired by the service provider. The “time slot” includes a time such as a start time or end time, and the length of time. For example, in a case where the service use time slot which is desired by the service user U does not fall within the service provision time slot which is desired by the service provider S, the plan decider 740 may limit the time slot in which the service user U occupies at least a portion of the vehicle 500 rather than the service use time slot which is desired by the service user U, and perform adjustment so as to fall within the service provision time slot. On the contrary, for example, in a case where the service provision time slot which is desired by the service provider S does not fall within the service use time slot which is desired by the service user, the plan decider 740 may limit the time slot in which the service provider S occupies at least a portion of the vehicle 500 rather than the service provision time slot which is desired by the service provider S, and perform adjustment so as to fall within the service use time slot. The plan decider 740 specifies an available service on the basis of the set third section.

In addition, in a case where a plurality of services providers S sequentially provide services to a certain service user U, the plan decider 740 may set second sections to correspond to the plurality of services providers S, and set a plurality of third sections corresponding to the respective second sections.

As another function, the plan decider 740 may update the first section so that the first section ends with a service provision point outside of a vehicle in accordance with an indication from the service user U using the terminal device 100. In this case, the plan decider 740 may transmit reservation information to a facility present at the service provision point outside of a vehicle using the communication unit 710 in accordance with the indication from the service user U using the terminal device 100 (or automatically), receive a reservation result through the communication unit 710, and transmit the reservation result to the terminal device 100 of the service user U using the communication unit 710.

The route indicator 750 indicates a route along which the vehicle 500 will travel to the vehicle 500 by causing the communication unit 710 to transmit information of a use start position and a use end position of the service user U and information of a use start position and a use end position of the service provider S to the vehicle 500.

The authentication unit 760 performs authentication of the service user U through communication with the terminal device 100, or performs authentication at the time of service provision start.

The determination unit 770 determines whether the service user U and each of the service providers S use the vehicle 500.

The plan decider 740 performs various processes using a determination result of the determination unit 770. For example, the plan decider 740 may accept a change of the first section (update the first section) only in a case where it is determined by the determination unit 770 that both the service user U and the service provider S use the vehicle 500. This case occurs, for example, when the service provider S gives a suggestion to the service user U to change a destination, or change a final destination during a service on the basis of information which is provided to the vehicle 500 side. In addition, in a case where the determination unit 770 determines that the service user U already uses the vehicle 500 (that is, a case where service extension or a separate service request is performed during service use) at a point in time when the first acquisitor 720 has received the service use request information, the plan decider 740 may preferentially allocate the vehicle 500 during the use to the service user U.

Service management information 830 is stored in the storage 800 in addition to user information 810 on the registered service user U and the above-described available vehicle information 820. The service management information 830 includes, for example, service request management information 832, reservation management information 834, and in-execution service management information 836. Each piece of the service use request information acquired by the first acquisitor 720 is registered as a record with the service request management information 832. Information such as a reservation use section, a reservation use time slot, a transit point, or an estimated time of arrival at a transit point is stored in the reservation management information 834 for each service. Information such as a service status, a service attribute, or a service provider ID is registered with the in-execution service management information 836.

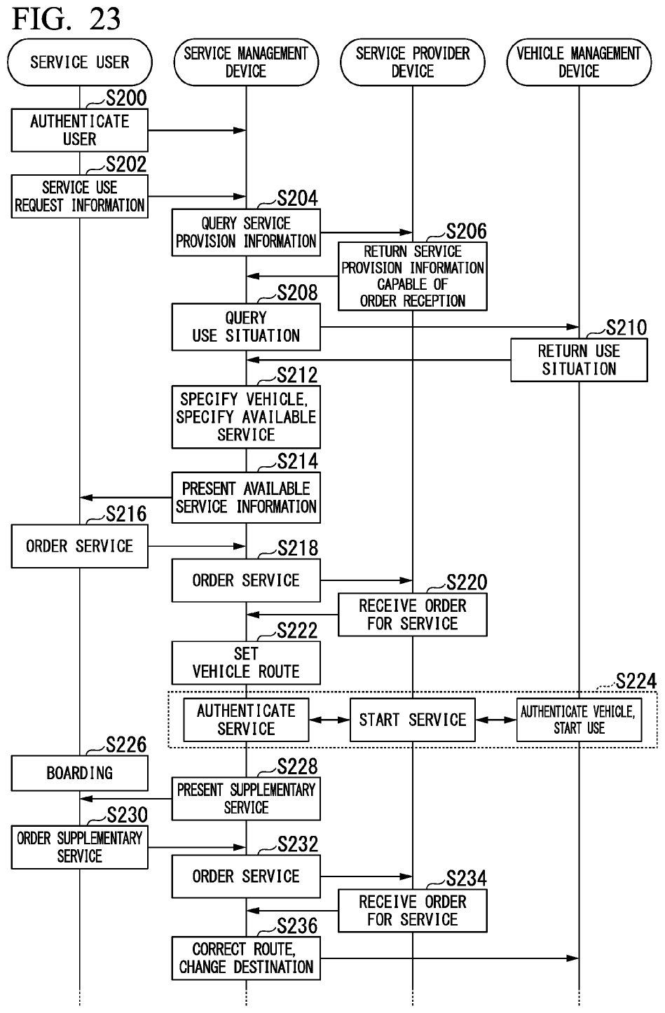

FIG. 23 is a flow chart illustrating an example of a flow of processes which are executed in the service providing system 2. First, a service requester A (a service user U) performs user authentication with respect to the authentication unit 760 of the service management device 700 using the terminal device 100 (step S200). In a case where authentication performed by the authentication unit 760 is successful, the service requester A (the service user U) transmits the service use request information to the service management device 700 using the terminal device 100 (step S202). The service use request information is acquired by the first acquisitor, and is stored in the storage 800 as the service request management information 832.

In a case where the service use request information is acquired, the third acquisitor 724 of the service management device 700 queries the service provider device 600 about the service provision information (step S204). A plurality of service provider devices 600 may be present depending on the attribute of a service to be provided or a service provider. In that case, the third acquisitor 724 may query a plurality of service provider devices 600 all at once. The state management unit 630 of the service provider device 600 returns service provision information (indicating content of a service for which an order can be received) related to a service for which an order can be received to the service management device 700 (step S206).

On the other hand, the second acquisitor 722 of the service management device 700 queries the vehicle management device 510 about a use situation (vehicle information) (step S208). The vehicle/compartment management unit 550 of the vehicle management device 510 returns a use situation detected by the use situation detection unit 552 to the service management device 700 (step S210). Meanwhile, the processes of step S208 and step S210 may be performed as needed at any timing asynchronously with the process shown in the flow chart.

Next, the vehicle specifier 730 specifies an available vehicle on the basis of the service use request information and the information acquired in step S210, and generates available vehicle information (step S212). A plurality of vehicles may be specified in step S212. In that case, the final specification of a vehicle may be performed from the previous steps to step S224 to be described later. The plan decider 740 specifies an available service which is able to be enjoyed by the service user on the basis of the available vehicle information and the service provision information, acquired in step S206, for which an order can be received (step S212), and transmits available service information indicating content of the specified available service to the terminal device 100 (step S214).

The service applicant A (the service user U) browses the available service information, and orders a service from the service management device 700 using the terminal device 100 as a result (step S216). The plan decider 740 of the service management device 700 extracts a portion of which the service provider takes charge among services for which an order is received in step S216, and orders a service from the service provider device 600 (step S218).

The order reception processing unit 620 of the service provider device 600 transmits service order reception to the service management device 700 (step S220). Simultaneously with this, the order reception processing unit 620 transmits order reception content to a terminal device of a service provider (not shown in the present embodiment).

In a case where the effect of order reception is received from the service provider device 600, the route indicator 750 of the service management device 700 sets a route along which the vehicle 500 will travel for service provision (step S222).

Next, the authentication unit 760 of the service management device 700 performs an authentication process for service start with respect to the service provider device 600 and the authentication unit 530 of the vehicle 500, the route indicator 750 indicates the route which is set in step S222 to the vehicle 500, the service provider device 600 performs authentication of service start and performs final specification of a vehicle as necessary, and the authentication unit 530 performs authentication on the vehicle side in the vehicle management device 510 of the vehicle 500 and starts or schedules traveling on the indicated route (step S224).

Thereafter, the service user U boards the vehicle 500 (step S226), and when a supplementary service can be presented, the plan decider 740 presents the supplementary service to the terminal device 100 (step S228). In a case where the service user browses content of the supplementary service and the supplementary service is ordered using the terminal device 100 (step S230), the plan decider 740 of the service management device 700 performs service ordering on the supplementary service with respect to the service provider device 600 (step S232). The order reception processing unit 620 of the service provider device 600 transmits information indicating that an order of the supplementary service has been received to the service management device 700 (step S234). In a case where the information indicating an order of the supplementary service has been received is received, the route indicator 750 of the service management device 700 indicates route correction or destination change to the vehicle 500 (step S236).

According to the fifth embodiment described above, the vehicle information is acquired from candidates of vehicles 500 registered in advance and available vehicles 500 are specified on the basis of the service use request information in addition to the exhibition of the same effect as that of the first embodiment, whereby it is possible to promote more positive use of the vehicle 500.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, the service management device 300(700) may be mounted in the vehicle 200(500).

In addition, in a case where the vehicle 200(500) is a manually driven vehicle, the communication unit 310(710) may communicate with a terminal device of a driver of the vehicle 200(500) through the network NW.

In addition, the vehicle 200(500) may be a remotely operated vehicle which is remotely operated from a remote place. In this case, the vehicle 200(500) transmits various types of information acquired by the outside monitoring unit 210 to an external device through the communication device 220. In the external device, an image indicating the surrounding situation of the vehicle 200(500) is generated (or reproduced) on the basis of the received various types of information, and is presented to a remote operator. In this case, an image or the like may be corrected by look-ahead processing in order to cover a delay due to communication. The remote operator operates a driving operator on the basis of a presented image. The content of an operation performed on the driving operator is transmitted to the vehicle 200(500), and the vehicle 200(500) travels on the basis of the received content of an operation.

What is claim is:

1. A service management device comprising:
an acquisitor that acquires a riding-together request in which a user and a service provider ride a moving vehicle together; and
a plan decider that decides a riding-together plan of the service user and the service provider in response to the riding-together request acquired by the acquisitor;
wherein the service provider is other than a driver of the vehicle.

2. The service management device according to claim 1,
wherein the riding-together request includes information of a first boarding section in which the service user boards the vehicle.

3. The service management device according to claim 2,
wherein the service user is a user for whom boarding the vehicle alone is not desirable, and
the plan decider decides a second boarding section in which the service provider boards the vehicle so as to include the first boarding section.

4. The service management device according to claim 2,
wherein the plan decider refers to information of an area in which the service provider is able to board the vehicle, and decides a second boarding section in which the service provider boards the vehicle so that the service provider rides together with the service user within a range of an overlap between the first boarding section and the area.

5. The service management device according to claim 1,
wherein the plan decider decides the riding-together plan so that the service user exits a vehicle at a point capable of association with a post-exit service which is received by the service user after exiting.

6. The service management device according to claim 5,
wherein the plan decider executes an online reservation required for the post-exit service.

7. The service management device according to claim 1,
wherein the plan decider selects a service provider according to a type of service designated in advance, and decides a riding-together plan of the service user and the selected service provider.

8. The service management device according to claim 1,
wherein the vehicle is an autonomously driven vehicle having a wireless communication function, and
the service management device further comprises:
a communication unit that communicates with the vehicle; and
a route indicator that causes the communication unit to transmit an indication of a route based on the riding-together plan decided by the plan decider to the vehicle.

9. A service providing system comprising:
the service management device according to claim 8; and
the vehicle,
wherein the service management device transmits an estimated time of service provision together with the indication of the route to the vehicle, and
the vehicle performs driving control not to arrive at a destination before an elapse of the estimated time of service provision.

10. A service management method by a computer, comprising:
acquiring a riding-together request in which a user and a service provider ride a moving vehicle together; and
deciding a riding-together plan of the service user and the service provider in response to the acquired riding-together request,
wherein the service provider is other than a driver of the vehicle.

11. (canceled)

12. A service management device comprising:
a first acquisitor that acquires service use request information of a service user who uses a service with use of a vehicle;
a second acquisitor that acquires vehicle information of a vehicle registered in advance;
a vehicle specifier that specifies an available vehicle on the basis of the service use request information and the acquired vehicle information, and generates available vehicle information;
a third acquisitor that acquires service provision information related to a service for which a service provider who provides a service with use of a vehicle is able to receive an order; and
a plan decider that specifies an available service which is able to be enjoyed by the service user on the basis of the available vehicle information and the service provision information, and provides information on the specified available service to the service user,
wherein the service provider is other than a driver of the vehicle.

13. The service management device according to claim 12,
wherein the service use request information includes information of a first section in which the service user occupies at least a portion of the vehicle.

14. The service management device according to claim 13,
wherein the service use request information includes attribute information of the service provider which is desired by the service user.

15. The service management device according to claim 13, further comprising a plan decider that sets a second section in which the service provider occupies at least a portion of the vehicle on the basis of the available vehicle information and the service provision information, and sets a third section in which the service user and the service provider occupy at least a portion of the vehicle on the basis of an overlap between the first section and the second section.

16. The service management device according to claim 13,
wherein the service provision information includes information of a service providable area, and
the service management device further comprises a plan decider that sets a third section in which the service user and the service provider occupy at least a portion of the vehicle within an overlap range between the first section and the information of the service providable area.

17. The service management device according to claim 13,
wherein the service provision information includes information of a service provision point outside of a vehicle, and
the service management device further comprises a plan decider that updates the first section so that the first section ends with the service provision point outside of the vehicle in accordance with an indication from the service user.

18. The service management device according to claim 13, further comprising a determination unit that determines whether both the service user and the service provider use the vehicle,
wherein the plan decider updates the first section in a case where it is determined by the determination unit that both use the vehicle.

19. The service management device according to claim 17, further comprising a communication unit that transmits reservation information for reserving a facility located at the service provision point outside of the vehicle, and receives a reservation result corresponding to the reservation information.

20. The service management device according to claim 12,
wherein the vehicle is an autonomously driven vehicle having a wireless communication function, and
the service management device further comprises:
a communication unit that communicates with the vehicle; and
a route indicator that causes the communication unit to transmit information of a use start position and a use end position of the service user and information of a use start position and a use end position of the service provider to the vehicle.

21. The service management device according to claim 15,
wherein the service use request information includes information of a service use time slot which is desired by the service user, and
the plan decider sets the third section so that a time slot in which the service user occupies at least a portion of the vehicle is coincident with the service use time slot.

22. The service management device according to claim 21,
wherein the service provision information includes information of a service provision time slot which is desired by the service provider, and
the plan decider sets the third section so that a time slot in which the service provider occupies at least a portion of the vehicle is coincident with the service provision time slot.

23. The service management device according to claim 15,
wherein, in a case where the second section is set to correspond to each of a plurality of services providers, the plan decider sets a plurality of the third sections corresponding to a plurality of the second sections.

24. The service management device according to claim 12, further comprising:
a determination unit that determines whether the service user uses the vehicle at a point in time when the first acquisitor receives the service use request information; and
a plan decider that preferentially allocates the vehicle in use to the user in a case where it is determined by the determination unit that the service user uses the vehicle.

25. A service management method by a computer, comprising:
acquiring service use request information of a service user who uses a service with use of a vehicle;
acquiring vehicle information of a vehicle registered in advance;
specifying an available vehicle on the basis of the service use request information and the acquired vehicle information to generate available vehicle information;
acquiring service provision information related to a service for which a service provider who provides a service with use of a vehicle is able to receive an order; and
specifying an available service which is able to be enjoyed by the service user on the basis of the available vehicle information and the service provision information, and provide information on the specified available service to the service user,
wherein the service provider is other than a driver of the vehicle.

26. (canceled)
